(19) United States
(12) Patent Application Publication
(10) Pub. No.: US 2001/0014878 A1
(43) Pub. Date: Aug. 16, 2001

(54) TRANSACTION METHOD AND APPARATUS

(76) Inventors: NILOTPAL MITRA, NEW YORK, NY (US); YZHAK RONEN, WEST WINDSOR, NJ (US)

Correspondence Address: SAMUEL H DWORETSKY, AT & T CORPORATION, P O BOX 4110, MIDDLETOWN, NJ, 077484801

(21) Appl. No.: 09/188,595

(22) Filed: Nov. 9, 1998

(51) Int. Cl. G06F 17/60

(52) U.S. Cl. 705/39; 705/40; 705/26

(57) ABSTRACT

The invention provides a transaction system in a data network that permits transactions among a buyer, a seller, and a billing device to occur independently. The transaction system may include authorizing tokens, seller cookies and purchase tokens to provide security, efficiency as well as independent operation. The purchase token is issued by the billing device to the buyer for transactions with sellers. The seller may issue a seller cookie to the buyer so that future transactions between the buyer and the seller may occur without interacting with the billing device. The billing device may issue an authorizing token to approve a buyer purchase order and to assure the seller that the buyer account is sufficient to cover prospective purchases. The authorizing token permits the seller to send an invoice to the billing device without being tied to specific transactions with the buyer. The billing device bills the buyer based on agreements between the buyer and the billing device which is independent of buyer-seller transactions. Thus, the transactions between the buyer and the seller, the seller and the billing device, and the billing device and the buyer may all occur at times that are independent of each other.

### BACKGROUND OF THE INVENTION

1. Field of Invention

The invention relates to a method and apparatus for conducting transactions between a buyer and a seller in a data network.

2. Description of Related Art

Traditional methods for completing transactions between a buyer and a seller conclude with the seller presenting an invoice to the buyer and the buyer paying the seller based on the invoice. However, when transactions are conducted electronically over a data network, the conventional payment method for purchases may be inefficient. Thus, new technology is required to facilitate transactions conducted between sellers and buyers over data networks.

### SUMMARY OF THE INVENTION

The invention provides a transaction system operating in a data network that permits a buyer and a seller to conduct transactions independent of invoice and payment interactions between the seller and a billing device to pay for the buyer-seller transactions. In addition, the billing and payment process between the billing device and the buyer (who ultimately pays for the buyer-seller transactions) may occur independently of both the buyer-seller and the seller-billing device relationships.

The transaction system may include authorizing tokens, seller cookies and purchase tokens to ensure independence, security and efficiency of the above transactions. When a buyer becomes a client of the billing device by subscribing to a billing service of the billing device, the billing device establishes a buyer account for the buyer and may issue a purchase token to the buyer to be used in transactions with sellers. For example, when the buyer desires to purchase a subscription for a seller service or an item from the seller, a copy of the purchase token may be given to the seller. The seller may gain assurance of payment for the purchase from the billing device by gaining approval for a purchase order from the billing device based on the purchase token.

When the seller contacts the billing device for purchase order approval, the billing device may issue an authorizing token to the seller which assures the seller that the buyer account is sufficient to cover the purchase. The seller may forward the authorizing token together with invoices when billing the billing device for outstanding charges.

Once the purchase order is approved, the seller may issue a seller cookie to the buyer so that future transactions between the buyer and the seller may occur without further interactions between the seller and the billing device. The seller may maintain an account for the buyer. When this occurs, the billing device may allocate funds in the buyer account based on buyer instructions. Thus, the seller may satisfy purchases of the buyer in the future based on the seller's account without additional interaction with the billing device.

The seller may send an invoice to the billing device for buyer purchases based on its own accounting administration requirements, for example, without being tied to specific transactions with the buyer. When an invoice is received, the billing device pays the invoice using the funds in the buyer account. The invoice and payment between the seller and the billing device may occur at a time that is independent of the billing and payment cycle between the billing device and the buyer because payment may be made from the buyer account without explicit notification to or authorization from the buyer.

The billing device bills the buyer based on agreements between the buyer and the billing device. For example, the buyer may instruct the billing device to maintain an account based on a fixed amount of monthly payments. In addition, the buyer may also apply for a credit arrangement with the billing device so that invoices that exceed the amount in the account balance may be satisfied by a loan from the billing device to the buyer. The loan amount may be paid off by the regular monthly payments, for example, that the buyer makes to the billing device.

The billing device may also maintain accounts relating to particular sellers on the buyer's behalf. Thus, the billing device may accept, deny or delay purchases made by the buyer based on overall buyer account status. In this way, the buyer is relieved from administering accounts with each of the sellers and relies on the billing device to manage expenses based on a regular payment schedule, for example. Thus, the transactions between the buyer and the seller, the seller and the billing device, and the billing device and the buyer may all occur at times that are independent of each other.

### BRIEF DESCRIPTION OF THE DRAWINGS

The invention is described in connection with the following figures wherein like numerals represent like elements, and wherein

FIG. 1 shows a diagram of a transaction system;

FIG. 2 shows an exemplary account database for a billing device;

FIG. 3 shows an exemplary diagram of an authorizing token;

FIG. 4 shows an exemplary diagram of a seller cookie;

FIG. 5 shows an exemplary diagram of a purchase token;

FIG. 6 shows an exemplary block diagram of the billing device;

FIG. 7 shows an exemplary flowchart of a process of the billing device;

FIG. 8 shows an exemplary block diagram of a seller device;

FIG. 9 shows an exemplary flowchart of a purchase request process of a seller device;

FIG. 10 shows an exemplary billing process of the seller device; and

FIG. 11 shows an exemplary buyer cancellation process of the seller device.

### DETAILED DESCRIPTION OF PREFERRED EMBODIMENTS

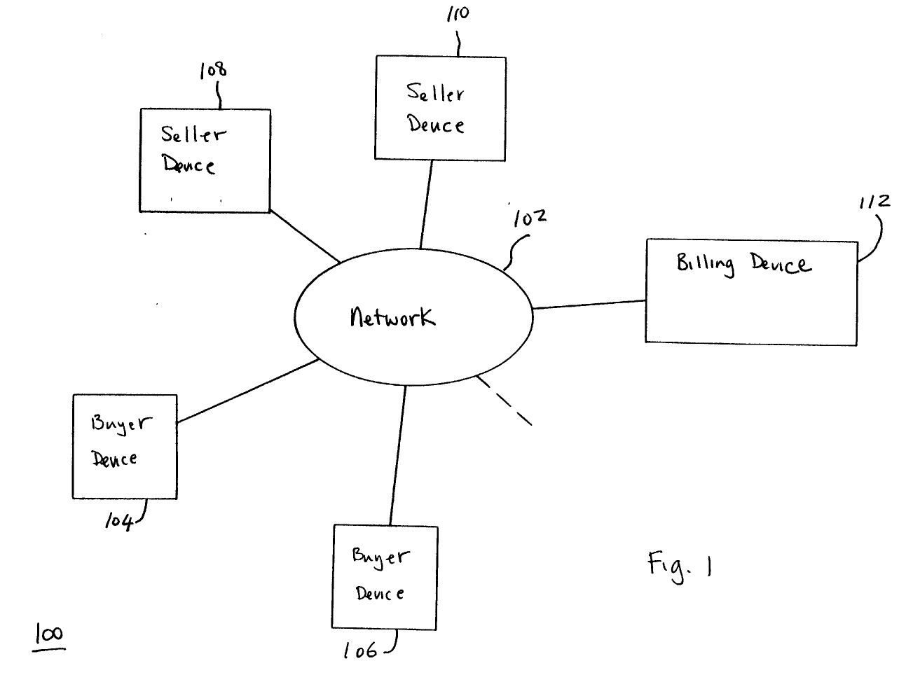

FIG. 1 shows an exemplary block diagram of a transaction system 100 that includes a network 102, buyer devices 104 and 106, seller devices 108 and 110, and a billing device 112. The network 102 may include a telephone network or a data network such as the Internet, for example. Such networks may be used as intranets, wide area networks or local area networks.

The buyer devices 104 and 106 may be devices such as personal computers that have network access capabilities. For example, a buyer may be a purchaser for a corporation who accesses the network 102 through a UNIX workstation, or the buyer may be a private individual accessing the Internet using a personal computer. Similarly, the seller devices 108 and 110 may be mainframes, servers, workstations, or personal computers of corporate sellers or private individuals selling various items and services. For the remaining discussion, seller/seller devices 108, 110 are used interchangeably as the context requires to refer to the seller entity and similarly with buyer/buyer device 104, 106.

The billing device 112 provides billing services (a payment agent or payer) without necessarily disclosing the identity of the buyers to the sellers so that the buyers may anonymously purchase subscriptions or items from the sellers over the network 102. The buyers may be billed on a regular basis by the billing device 112 for transactions conducted with different sellers independent of specific transactions. Each of the sellers may independently send invoices for their transactions with the buyer to the billing device 112. Thus, the buyer-seller transaction process is separated from the buyer-seller device payment process.

For example, a buyer using the buyer device 104, 106 may have subscribed to a billing service with the billing device 112. The buyer (now client of the billing device 112) may peruse various web sites supported by seller devices 108 and 110 on the network 102 (e.g., the Internet, for example). If the buyer is interested in purchasing a subscription of a database service supported by the seller device 108, 110, for example, the buyer, through the buyer device 104, 106, may select a subscription option (a purchase request) and identify the billing device 112 as a payment agent, for example. The buyer may include instructions in the purchase request for the seller device 108, 110 or the billing device 112 to maintain a specific account in connection with the particular seller. Such an account may specify a regular payment into the account to cover purchases in the future as well as request for a credit arrangement.

The buyer may also choose to remain anonymous to the seller device 108, 110. The seller device 108, 110 has no means to determine the identity of the buyer device 104, 106 via the network connection but can only identify a pseudonym that the buyer arbitrarily chooses or is assigned by the network 102, for example. Thus, the seller device 108, 110 can only associate the information provided by the buyer device 104, 106 with the pseudonym of the buyer device 104, 106 that allows the seller device 108, 110 to transact with the buyer device 104, 106 through the web site.

After receiving the purchase request, the seller verifies the purchase information (e.g., whether items or seller services identified are still being offered and whether the prices are still valid) and then checks for identifying information for billing purposes. For example, the buyer may have included a purchase token that was obtained from the billing device 112 when the buyer subscribed to the billing service offered by the billing device 112. The purchase token may contain explicit identification of the billing device 112 and a buyer identification that is encrypted to protect the anonymity of the buyer to the seller. The seller verifies the items and prices identified in the purchase request and converts the purchase request into a purchase order by electronically signing the purchase request. The seller may seek approval of the purchase order from the billing device 112 directly using the information in the purchase token and complete the transaction with the buyer without further action from the buyer. Thus seller efficiency and buyer convenience may both be achieved.

When a request for approval of a purchase order is received from a seller device 108, 110, the billing device 112 verifies that the buyer identified by the information in the request is a client of the billing device 112 and that the buyer account has sufficient funds to cover the new purchase or subscription. If sufficient funds are available in the buyer account, the billing device 112 sends an authorizing token to the seller device 108, 110 to approve the purchase order, assuring the seller that the buyer account is sufficient to cover the additional costs. When the authorizing token is received, the seller device 108, 110 may indicate to the buyer that the purchase order is accepted.

The seller device 108, 110 may also send to the buyer device 104, 106 a seller cookie that includes authorization information such as a password, for example, and any other information that facilitates authentication of future accesses to seller services or purchases, for example. Whenever a buyer accesses the resources provided by the seller device 108, 110, the seller device 108, 110 may verify that the buyer is a prior customer of the seller via the seller cookie. If the buyer subscribes to services of the seller, then the seller cookie may serve as a seller authentication device to permit multiple accesses of seller services without repeated interactions with the billing device 112.

If the purchase request does not contain sufficient information for billing (i.e., only identifies billing device 112 but no specific indication of buyer such as encrypted buyer identification) then the seller 108, 110 verifies the purchased items and/or subscriptions and the associated prices, electronically signs the purchase request, and returns the signed purchase request to the buyer.

After the signed purchase request is received, the buyer may also electronically sign the purchase request to convert it into a purchase order and sends the purchase order to the billing device 112 for approval. Upon receiving the purchase order, the billing device 112 retrieves the corresponding buyer account and if the account can support the purchase order, the billing device 112 generates an authorizing token and sends the authorizing token to the seller device 108, 110 based on seller identification information in the purchase order. The seller identification information may be placed in the original purchase request by the seller (e.g., a page in the seller's web site) or when the seller signs the purchase request. The authorizing token contains encrypted information to protect the anonymity of the buyer, but also contains information accessible by the seller sufficient to complete the billing process. After the seller receives the authorizing token, the seller may complete the transaction with the buyer.

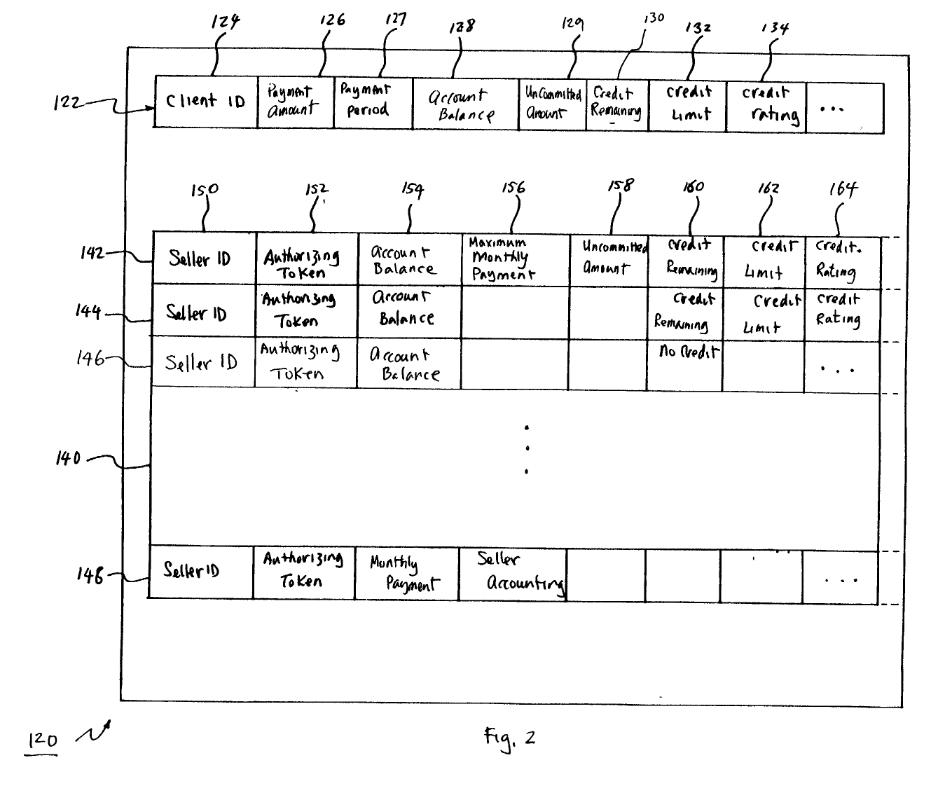

The above transaction processes may begin when a buyer subscribes to a billing service offered by the billing device 112 and thus becomes a client of the billing device 112. As shown in Table 1 below, after the buyer subscribes to the billing service, row 1, the billing device 112 generates a buyer profile and records buyer information in the profile. For example, as shown in FIG. 2, the buyer profile 122 in a buyer database 120 may include a buyer ID 124 that uniquely identifies the specific buyer. Other information such as a payment amount 126 and a payment period 127 may be selected by the new client while engaged in the subscription process.

TABLE 1

| | BUYER | BILLING DEVICE | SELLER |
|---|---|---|---|
| 1 | Subscribes to Billing | | |
| | Service | | |
| 2 | | Generates Buyer Profile and | |
| | | Records Buyer Information in | |
| | | Profile | |

For example, the buyer may choose to have a monthly payment of $50 to pay for all the purchases or services that the buyer may choose to expend. The billing device 112 may, subsequent to the buyer's subscription to the billing service, bill the buyer $50 monthly, independent of whether the buyer has actually incurred the expenses. The billing device 112 maintains an account balance 128 so that the unexpended payments may be accumulated in the account balance 128 to cover future expenses that may exceed the monthly payment amount.

If the buyer purchases a subscription for a seller service or an on-line magazine, for example, the periodic payment must be made to maintain the subscription. The cost of this periodic payment is subtracted from the payment amount 126 and saved as the uncommitted amount 129 to indicate the surplus of funds after each payment period that remain available to cover other costs. The above assumes that the buyer payment period is the same as the subscription payment period. Different buyer payment and subscription payment periods are also possible and may be easily accounted for.

The billing device 112 may also extend credit to the buyer so that the buyer may make purchases beyond the amount remaining in the account balance 128 and apply the uncommitted amount 129 to paying off the loaned amount. Thus, the buyer profile 122 may include fields such as credit remaining 130, credit limit 132 and credit rating 134. Other fields may also be included to support additional account features. The remaining entries in the buyer database 120 will be discussed later.

In view of the above, a buyer may make any number or types of transactions with sellers and simply direct the sellers to the billing device 112 for payment of the transactions. As already discussed, before completing the transaction, the sellers may seek approval of purchase orders from the billing device 112. Once approved, the seller may complete the transaction and send an invoice to the billing device 112 either immediately or on a periodic basis such as payments for a subscription to services offered by the seller. Thus, the seller may invoice the billing device 112 at a time that is independent of the time or number of the transaction with the buyer and independent of the time when the billing device 112 bills the buyer.

Moreover, the buyer is relieved of the payment management tasks associated with multiple sellers by making a single regular payment to the billing device 112 to pay all costs associated with transactions with different sellers. Sellers are also relieved of the tasks to synchronize billing with buyer transactions. In this way, sellers may optimize their billing practices based on internal administrative needs alone. For example, invoices may be sent to the billing device 112 on a periodic basis based on an internal business cycle.

As shown in Table 2 below, the billing device 112 bills the buyer on regular intervals based on the payment period 127 in the buyer profile 122 (row 1). The bills may be sent to the buyer either via regular mail or electronically to the buyer device 104, 106. Alternatively, the billing device 112 may have received authorization to transfer funds directly from the buyer's bank account. After receiving the buyer's response, row 2, which may be either payment or nonpayment, the billing device 112 updates the account status, row 3, such as adjusting the account balance 128 and updating the credit remaining 130 or the credit rating 134.

TABLE 2

| | BUYER | BILLING DEVICE | SELLER |
|---|---|---|---|
| 1 | | Bills Buyer on Regular Intervals | |
| | | and Provides Account Status | |
| 2 | Responds to Billing | | |
| | Device When Billed | | |
| 3 | | Updates Account Status Based on | |
| | | Response | |

After subscribing to the billing service of the billing device 112, the buyer may make purchases from sellers by a process as shown in Table 3. In row 1, the buyer decides to purchase a subscription or an item from the seller. The buyer may complete a purchase form of the seller supplied by the seller's web site, for example, and submit the completed form to the seller. In row 2, the seller verifies the information in the purchase request (subscription or purchase items still available and the price is correct) and if acceptable, electronically signs the purchase request and returns the signed purchase request to the buyer. Electronic signatures are known in the art and may include encrypting the complete document using a seller encryption and appending the encrypted file to the purchase request.

TABLE 3

| | BUYER | BILLING DEVICE | SELLER |
|---|---|---|---|
| 1 | Purchase Request to | | |
| | Seller | | |
| 2 | | | Verifies Purchase |
| | | | Request, Signs |
| | | | Purchase Request, |
| | | | and Returns |
| | | | to Buyer |
| 3 | Sends Signed Purchase | | |
| | Order to Billing Device | | |
| 4 | | Generates Auth- | |
| | | orizing Token | |
| | | and Send to | |
| | | Seller Based on | |
| | | Buyer Account | |
| | | Status | |
| 5 | | | Receives Author- |
| | | | izing Token |
| 6 | | | Issues Seller |
| | | | Cookie |
| 7 | Saves Seller Cookie for | | |
| | Future Purchases | | |
| 8 | | | Delivers Purchased |
| | | | Product |

The buyer converts the purchase request into a purchase order by accepting the conditions in the signed purchase request, includes buyer identification information and any instruction for the billing device 112 to maintain an account for the specific seller, and optionally signs the purchase order before sending the purchase order to the billing device 112. In row 4, the billing device 112 receives the purchase order and verifies that the buyer account associated with the buyer identification information has sufficient resources to cover the new purchase. If verified, the billing device 112 generates an authorizing token and sends the authorizing token to the seller, thus authorizing the seller to fill the purchase order. When generating the authorizing token, the billing device 112 also updates the buyer account such as reducing the account balance 128, the uncommitted amount 129, or the credit remaining 130, as appropriate.

The billing device 112 may send the authorizing token to the seller device 108, 110 either directly or by way of the buyer device 104, 106. The seller identification in purchase order may be a seller address in the network 102, for example. Thus, the ling device 112 may simply send the authorizing token to the seller address.

The network browser in the buyer device 104, 106 may include a forward feature such as available for Internet network browsers, where the billing device 112 may return the authorizing token to the buyer device 104, 106 with a forwarding flag set so that the authorizing token is automatically forwarded to the seller device 108, 110 via the buyer device 104, 106. This method relieves the billing device 112 of the additional step of retrieving and incorporating the seller's network address.

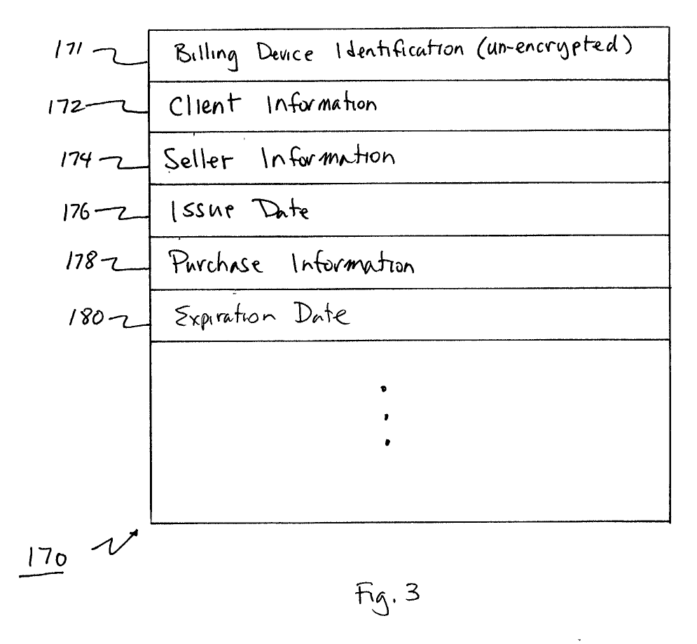

FIG. 3 shows an exemplary diagram of contents of the authorizing token 170. The authorizing token 170 may include billing device identification 171, buyer information 172, seller information 174, issue date 176, purchase information 178 and expiration date 180. The authorizing token 170 may be protected by encrypting the information in entries 172-176 so that the buyer may remain anonymous to the seller. The billing device identification 171, the purchase information 178 and the expiration date 180 are not encrypted so that the seller may retrieve and use such information to complete the transaction. Other information may also be included in the authorizing token 170 as may be dictated by implementation details.

In row 5 of Table 3, the seller receives the authorizing token 170 from the billing device 112. The seller extracts the purchase information 178 to determine whether the billing device 112 will pay for the purchase order. If so, the seller may choose to issue to the buyer a seller cookie (row 6) to identify the buyer (though anonymous) to facilitate serving the buyer in the future. Also, if the purchase made by the buyer is a subscription to a service offered by the seller, the seller cookie may serve as an authorizing device for future accesses based on the subscription.

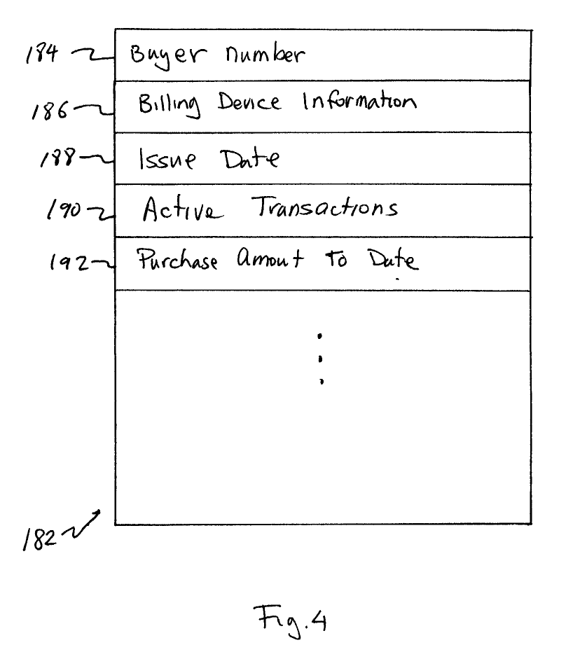

FIG. 4 shows an exemplary diagram of the contents of a seller cookie 182. The seller cookie 182 may include a buyer number 184, billing device information 186, issue date 188, active transactions 190 (e.g., subscription to seller services) and purchase amount to date 182, etc. The above information may be encrypted for security purposes to protect information that may be confidential to either the buyer or the seller.

Returning to Table 3, in row 7, the buyer receives the seller cookie 182 and saves the seller cookie 182 in connection with the seller so that the seller cookie 182 may be used for future transactions with the seller. In row 8, the seller delivers the purchase product (e.g., granting accesses to purchased services or software products) or delivering the purchased product via the network 102 or common carriers such as U.S. mail.

When the authorizing token 170 is issued to the seller, the billing device 112 may maintain account information relative to the specific seller. For example, as shown in FIG. 2, the billing device 112 may maintain a database 140 containing entries 142-148 associated with each individual seller with whom the buyer has made transactions. Common to all the entries 142-148 are the seller ID field 150 and the authorizing token field 152. Other fields such as fields 154-162 may contain information specific to each seller.

For example, in entry 142, the buyer has entered into a monthly billing arrangement with the seller. The monthly payment may support a subscription to services offered by the seller, for example. The buyer may have specified in the purchase order to limit a maximum monthly payment to this particular seller. The maximum monthly payment may be equal to the payment for the subscription in which case the uncommitted amount in field 156 is zero. However, the buyer may also purchase other items from the same seller and would like the billing device 112 to keep track of the amount of purchases made by the buyer so that the monthly payment will not exceed a maximum monthly payment as indicated in the field 154.

For example, the buyer may have purchased access to the seller's database for $50 a month. In addition to the $50 per month subscription, the buyer may also desire to purchase various magazines and supporting software to process the data obtained from the seller, for example. The buyer estimates that the additional purchases needed would average out to about $25 per month. Thus, the buyer may specify to the billing device 112 in the original subscription purchase order to limit the maximum monthly payment to $75 per month which is set in the field 156. Thus, after the subscription purchase order is approved, the uncommitted amount in field 156 would be $25 per month.

As time goes on, the buyer may purchase a magazine subscription which may cost $5 per month. When such a purchase order is received, the billing device 112 updates the field 156 to reduce the uncommitted amount to $20 per month.

If, on a particular occasion, the buyer signs a purchase order to purchase a $2,000 data search engine from the seller, the billing device 112 may determine that such a purchase order can be accepted after ten additional months because the buyer's payment is $20 per month in excess of the committed monthly payment as indicated in the field 158. The above assumes that the account balance 154 is zero. If the account balance contains $1,000, for example, then only five additional months are needed to pay for the purchase order. Thus, if the account balance is $1,000, the billing device 112 may issue an authorizing token 170 that indicates a delivery date of five months from the date of the purchase order so that sufficient funds may be accumulated by the billing device 112 from the buyer's monthly payment to pay for the new purchase.

Alternatively, the buyer may have entered into a credit relationship with the billing device 112 so that the billing device 112 may loan the buyer the $1,000 or up to a maximum amount as indicated in the credit limit field 162. If the credit limit field 162 indicates $2,000 and the buyer has already used $1,000 of the available credit, the credit remaining amount 160 would be zero after the purchase transaction. If the $1,000 additional loan is made, the billing device 112 would issue an authorizing token 170 to the seller for immediate delivery of the data search software and reduce the uncommitted amount in field 156 to zero for the number of months that is required to pay off the loan. The credit remaining amount in field 160 would be also set to zero and incremented by $20 as monthly payments are made.

The credit rating 162 is determined by the billing device 112 based on the payment history of the buyer, for example. Thus, the billing device 112 assists the buyer in managing payment for purchases made by the buyer and simplifies the buyer's financial plans because the billing device 112 guarantees a maximum monthly payment as set by the buyer.

Other types of accounts may also be incorporated as illustrated by the entries 144-148 shown in FIG. 2. For example, entry 144 shows that the buyer has a fixed amount of dollars as an account balance in the field 154. The account balance is set by the buyer either by explicit instruction to the billing device 112 or by instructions in the purchase order, for example, when purchasing items from this particular seller. The buyer may also indicate the amount of credit that is desired and the credit information is stored in fields 160-164.

In entry 146, the buyer has an account balance with the seller, but elected not to obtain any credit from the billing device 112. Thus, the field 160 indicates no credit. In entry 148, the buyer indicates that the accounting task for the seller is performed by the seller. In this case, the billing device 112 only deducts commitments to this seller in connection with the buyer profile 122. The billing device 112 updates the account balance in field 154 each time the buyer makes a purchase with this seller.

With specific sellers, the buyer may wish to establish an account with specific monthly limits as well as limits for one time purchases. The seller first interacts with the buyer and establishes the desired account and then validates the account with the billing device 112 to ensure that the payments made to the billing device 112 are sufficient to cover the account maintained by the seller. Thus, the billing device 112 provides great flexibility to the buyer in assisting the buyer to manage billing and payment with respect to sellers.

While the billing device 112 assists the buyer in maintaining accounts with each specific seller, the total amount committed to all the sellers cannot exceed the agreement between the buyer and the billing device 112 as indicated in entry 122. Thus, if the buyer sends in a purchase order and sets a maximum billing payment so that a total monthly payment is greater than the payment amount in the field 126, the billing device 112 would reject the purchase order unless the buyer has sufficient remaining credit as indicated in the credit remaining field 130 to cover the additional costs.

If the seller is maintaining an individual account for the buyer, the seller performs a process similar to the processes performed by the billing device 112 associated with entries such as entries 142, 144 and 146. When the seller is maintaining the buyer account, the seller is guaranteed that the funds are available by the billing device 112 for the committed amount. Thus, in this case, the seller may freely interact with the buyer and implement a seller validation scheme without having to interact with the billing device 112 for each transaction. For example, the seller may implement a validation scheme by placing appropriate information in the seller cookie 182 that is issued to a particular buyer.

The seller may choose to include information such as the information included in entries 142, 144 and 146, as shown in FIG. 2 in the seller cookie 182. Thus, each time a buyer enters into a transaction with the seller, the seller may update the seller cookie information so that accounting processes may be performed relative to that particular buyer.

As shown in Table 4 below, after the buyer subscribes to the billing service (row 1 ), the billing device 112 may issue a purchase token (row 2) to the buyer. The buyer device 104, 106 may save the purchase token (row 3) and use the purchase token to purchase items from various sellers.

TABLE 4

| | BUYER | BILLING DEVICE | SELLER |
|---|---|---|---|
| 1 | Subscribes to | | |
| | Billing Service | | |
| 2 | | Generates Buyer Profile, Records | |
| | | Buyer Information in Profile, | |
| | | Sends Purchase Token to Buyer | |
| 3 | Receives Purchase | | |
| | Token | | |

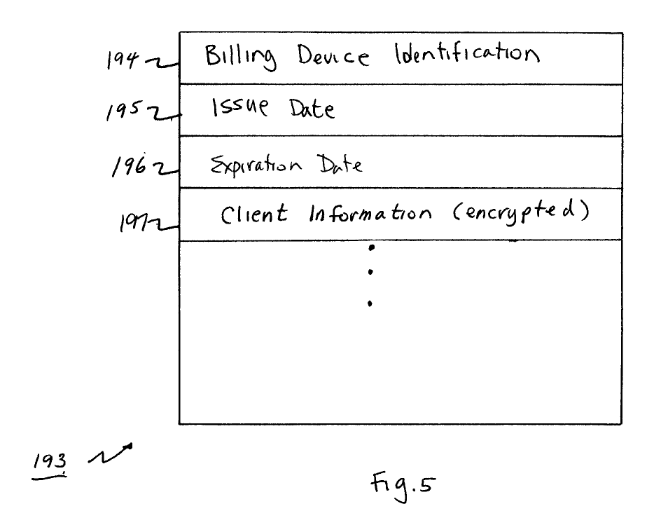

FIG. 5 shows an example of a purchase token 193. Unlike the authorizing token 170 and the seller cookie 182, the information in the purchase token 193 is unencrypted except for buyer information 197. For example, the purchase token 193 may include a billing device identification 194, an issue date 195, and an expiration date 196. Thus, all the information except for the buyer information 197 may be used by the seller to determine whether the buyer is a bona fide purchaser, where to obtain further validation, and where to bill for the purchased items. The buyer information 197 is encrypted to maintain anonymity of the buyer, if desired, with respect to the seller.

As shown in Table 5 below, when the buyer desires to purchase a subscription or an item from a seller (row 1), the buyer sends a purchase order directly to the seller that includes the purchase token 193. As discussed earlier, the buyer may specify whether the seller or the billing device 112 is to maintain an account for transactions with the specific seller and the maximum monthly payment as well as whether credit that may be extended by either the seller or the billing device 112. The buyer may electronically sign the purchase request and send the purchase request to the seller (instead of the billing device 112). When the signed purchase request is received, the seller verifies the information contained in the purchase request such as whether the purchase item is still being offered and whether the price is correct and applies the seller's signature to convert the purchase request to a purchase order and forwards the purchase order directly to the billing device 112 via information that is provided in the purchase token 193.

TABLE 5

| | BUYER | BILLING DEVICE | SELLER |
|---|---|---|---|
| 1 | Purchase Order | | |
| | to Seller With | | |
| | Purchase Token | | |
| 2 | | | Sends Signed Purchase |
| | | | Order to Billing Device |
| | | | Using Buyers Purchase |
| | | | Token |
| 3 | | Verifies Buyer via | |
| | | Purchase Token and | |
| | | Issues Authorizing | |
| | | Token to Seller | |
| | | Based on Buyer | |
| | | Account Status | |
| 4 | | | Receives Authorizing |
| | | | Token |
| 5 | | | Issues Seller Cookie |
| 6 | | | Delivers Purchased Product |

When the purchase order is received, the billing device 112 confirms whether the buyer is a client of the billing service and whether the buyer account status is sufficient to support the purchase made by the buyer. If sufficient funds are available (via either the account balance 128, uncommitted amount 129 or credit remaining 130), the billing device 112 generates an authorizing token 170 and sends the authorizing token 170 to the seller. The billing device 112 may further set up an account on behalf of the buyer for this particular seller as directed by the information in the purchase order (or updates an already existing account).

When the authorizing token 170 is received, the seller may deliver the purchased product to the buyer and also generate a seller cookie 182 to send to the buyer device 104, 106, for example, so that future transactions between the buyer and the seller may be more easily conducted. The billing device 112 may also send a new purchase token 193 to the buyer either periodically or as circumstances require. For example, if the purchase token's expiration date is within twenty-four hours, the billing device 112 may send the buyer a new purchase token 193 after verifying that the buyer account is in good standing.

Table 6 shows a process where the buyer makes a purchase from a seller using a seller cookie 182. In row 1, the buyer decides to purchase an item from the seller and prepares a purchase order and sends the purchase order to the seller together with the seller cookie 182. When the purchase order is received, the seller validates the buyer based on information in the seller cookie 182 such as checking the password, delinquent account, etc. If the buyer has established an account with the seller, the seller verifies that there are sufficient funds in the account to cover the purchase or if credit is extended to the buyer, that there is sufficient credit remaining. If the buyer account is validated (row 2), the seller may proceed to deliver the purchased product.

TABLE 6

| | BUYER | BILLING DEVICE | SELLER |
|---|---|---|---|
| 1 | Purchase Order to | | |
| | Seller With Seller | | |
| | Cookie | | |
| 2 | | | Validates Buyer Based on |
| | | | Seller Cookie |
| 3 | | | Issues Invoice to Billing |
| | | | Device Using Authorizing |
| | | | Token |
| 4 | | May Issue New | |
| | | Authorizing Token | |
| 5 | | | Delivers Purchase Product |

The seller may issue an invoice to the billing device 112 (row 3) at a time that is convenient to the seller and independent of the transactions conducted with the buyer. For example, the seller may choose to send an invoice to the billing device 112 immediately after the transaction with the buyer has been completed or may collect many transactions together and send a single invoice to the billing device 112 so that the number of interactions with the billing device 112 may be reduced.

If the billing device 112 is maintaining an account on behalf of the buyer for the particular seller, the seller may choose to verify that there are sufficient funds to cover the current purchase before delivering the purchased product. In such a case, the seller may wish to issue an invoice to the billing device 112 using the authorizing token 170 and only deliver the purchase product after the billing device 112 confirms that the buyer account has sufficient funds to purchase the product.

After receiving the invoice from the seller, the billing device 112 identifies the particular buyer via the information contained within the authorizing token 170 and verifies whether the buyer account has sufficient funds to pay for the purchase product. The billing device 112 may also issue a new authorizing token 170 to the seller depending on security requirements and buyer status such as amount of credit or status of the balance in the account. The billing device 112 updates the appropriate account information so that further purchase orders may be evaluated based on a most up-to-date status of the buyer account.

Table 7 shows a process where a buyer accesses a seller based on a prior subscription to a service offered by the seller. In row 1, the buyer accesses the seller using a seller cookie 182 that was received either after the completion of the purchase order or after a prior access. In row 2, the seller validates the buyer based on the seller cookie 182 to insure that the buyer's subscription is still valid and that the account has been paid for. Then, in row 3, the seller may optionally update the seller cookie 182 and send the new seller cookie 182 to the buyer to be saved in the buyer device 104, 106, for example. Then, in row 4, the seller grants the access to the buyer.

TABLE 7

| | BUYER | BILLING DEVICE | SELLER |
|---|---|---|---|
| 1 | Access Seller With | | |
| | Seller Cookie | | |
| 2 | | | Validates Buyer Based |
| | | | on Seller Cookie |
| 3 | | | Optionally Updates |
| | | | Seller Cookie |
| 4 | | | Grants Access |

As described above, the seller may validate a buyer via a purchase token 193, a seller cookie 180 or an authenticating token 170. None of the above methods require the seller to issue invoices to the billing device 112 at any particular time. Thus, the billing process and the buyer-seller transaction process are separated and may operate independently of each other.

Table 8 shows an invoice process of the seller to the billing device 112. In row 1, the seller issues an invoice to the billing device 112 at a time convenient to the seller. The invoice includes the authenticating token 170 received from the billing device 112 during a prior interaction such as approval of a purchase order. In row 2, the billing device 112 identifies a buyer based on the information in the authenticating token 170 and retrieves the buyer account. Then, in row 3, the billing device 112 determines whether the buyer account is sufficient to pay the invoice received from the seller.

TABLE 8

| | BUYER | BILLING DEVICE | SELLER |
|---|---|---|---|
| 1 | | | Issues Invoice to Billing |
| | | | Device With |
| | | | Authenticating Token |
| 2 | | Determines Buyer Account | |
| | | Status After Validation of Token | |
| 3 | | Pays/Denies/Delays Payment | |
| | | Based on Account Status | |
| 4 | | | Delivers/Delays/Rejects |
| | | | Purchase Based on |
| | | | Billing Device Response |
| | | | to Invoice |

If the billing device 112 is managing an account for this particular seller, then the buyer account had already been verified to be sufficient to cover the charges from this particular seller. In this case, the buyer account should have the funds available to cover the charges from the seller and the billing device 112 may simply satisfy the seller's invoice by paying the billed amount and updating the buyer account.

If the seller is managing an account for the buyer, then the buyer account managed by the billing device 112 may not have sufficient funds to cover the charges indicated in the seller's invoice. In this case, the billing device 112 analyzes the buyer account status and: 1) pays the invoice if the buyer account has sufficient fluids for payment; 2) denies the invoice by sending a message to the seller if the buyer does not have sufficient funds to cover the costs; or 3) sends a message to the seller to indicate a date when the buyer account may have sufficient fluids to cover the costs of the outstanding invoice.

In row 4, the seller delivers the purchased item or continues a subscription if the billing device 112 pays for the invoice. If the billing device 112 denies the payment of the invoice, the seller may decide to extend credit to the buyer, refuse delivery of the purchased item or terminate a subscription, for example.

Table 9 shows a process of the buyer canceling a subscription with the billing device 112. In row 1, the buyer sends a message to the billing device 112 to cancel the billing service of the billing device 112. In row 2, the billing device 112 sends cancel messages to all sellers to whom the billing device 112 has issued authorizing tokens 170. In row 3, the sellers that have received the cancel messages determine outstanding charges corresponding to the authorizing tokens 170 and send invoices to cover the outstanding charges to the billing device 112. In row 4, the billing device 112 satisfies the invoices from the sellers using the remaining balance in the corresponding buyer account. Then, in row 5, the billing device 112 sends a bill to the buyer for those devices for which the remaining balance in the buyer account was not able to cover. The billing device 112 also sends messages to those sellers whose invoices cannot be paid. In row 6, those unpaid sellers may decide to terminate services or stop delivery of purchased items. For the paid sellers, delivery of purchased items or completion of subscribed-to services may be performed. Then in row 7, the buyer may make a final payment to the billing device 112. In row 8, after receiving the final payment, the billing device 112 pays those sellers that were not paid in row 5 so that the purchase items or subscribe to services may be delivered. In row 9, the billing device 112 deletes the buyer as a client of the billing service.

TABLE 9

| | BUYER | BILLING DEVICE | SELLER |
|---|---|---|---|
| 1 | Cancels Subscription | | |
| | With Billing Device | | |
| 2 | | Informs All Sellers | |
| | | Having Authorizing | |
| | | Tokens | |
| 3 | | | Sends Outstanding |
| | | | Charges to Billing |
| | | | Device |
| 4 | | Pays Sellers And | |
| | | Informs Unpaid | |
| | | Sellers | |
| 5 | | Bills Buyer For | |
| | | Unpaid Purchases | |
| | | Or Refunds Remaining | |
| | | Balance | |
| 6 | Makes Final Payment | | |
| 7 | | Pays Unpaid Sellers | |
| | | If Final Payment | |
| | | received Or Informs | |
| | | Unpaid Sellers If No | |
| | | Final Payment | |
| | | Received | |
| 8 | | | Delivers Purchased |
| | | | Items If Paid |
| 9 | | Deletes Buyer | |

Table 10 shows a process where the buyer cancels a subscription with the seller. In row 1, the buyer informs the seller that the subscription is no longer desired. In row 2, the seller sends an end subscription notice to the billing device 112 and then invalidates the seller cookie 182 last issued to the buyer to terminate the subscription if the subscription was the only action transaction. If there are other active transactions, the seller may issue a new seller cookie 182 that removes the subscription as an accessible service. In row 3, the billing device 112 receives the end subscription notice from the seller and updates the buyer account by incrementing the uncommitted amount 129, for example. If the billing device 112 is maintaining an account in connection with the seller for the buyer, the account is updated to include only remaining active transactions. If no active transactions remain, then the account is deleted, for example.

TABLE 10

| | BUYER | BILLING DEVICE | SELLER |
|---|---|---|---|
| 1 | Cancels Subscription | | |
| | With Seller Device | | |
| 2 | | | Sends End |
| | | | Subscription Notice |
| | | | to Billing Device |
| | | | and Invalidates |
| | | | Corresponding |
| | | | Seller Cookie to |
| | | | Terminate Buyer |
| | | | Subscription |
| 3 | | Updates Buyer Ac- | |
| | | count and Invalidates | |
| | | Corresponding | |
| | | Authorizing Token | |

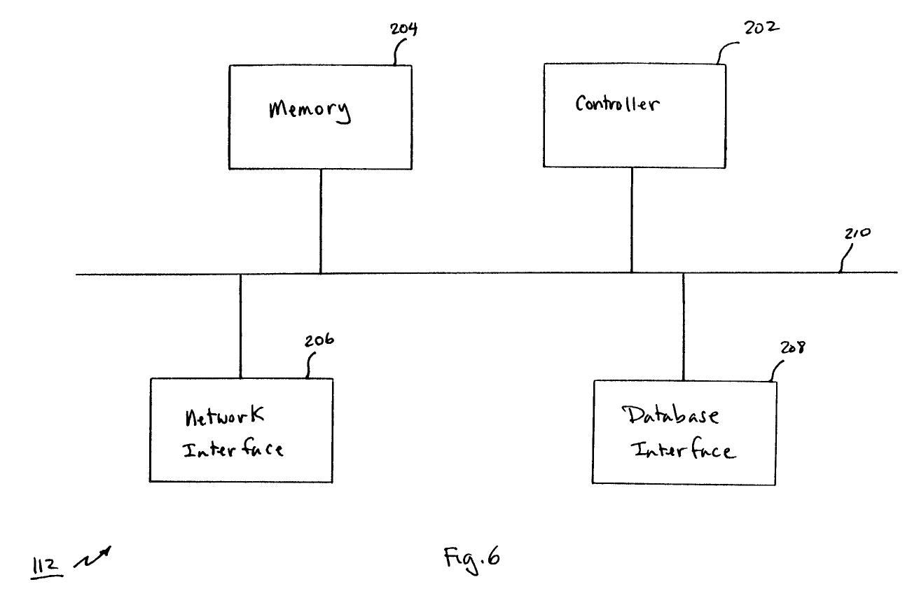

FIG. 6 shows an exemplary block diagram of the billing device 112. The billing device 112 may include a controller 202, a memory 204, a network interface 206 and a data interface 208. The data interface 208 may interface with a variety of storage devices which may be either local to the billing device 112 or may be distributed throughout the network 102. All of the above components are coupled together via signal bus 210. While the structure shown in FIG. 6 is one embodiment that is convenient for discussion purposes, other architectures may also be used as is well known in the art.

When an input is received from the network 102 through the network interface 206, the controller 202 determines whether the input is received from a buyer or a seller. For example, a buyer may send a request to the billing device 112 to begin subscription to the billing service supported by the billing device 112. While this discussion assumes that the input is received over the network 102, a buyer may personally enter an office, for example, and provide the information for a new subscription which may be entered at a terminal by a billing service agent. Thus, the information received from the buyer need not come through the network 102 or the network interface 206.

The input may also be a purchase order from a buyer to the billing device 112 for a purchase with a particular seller. Such a purchase order would be received by the controller 202 and processed accordingly.

Inputs from sellers may be to seek approval for a purchase order via a purchase token 193, an invoice with an authorizing token 170, or an end subscription notice, for example. Thus, the controller 202 may easily distinguish between sellers and buyers. For buyers that desire to subscribe to the billing service supported by the billing device 112, the controller 202 generates a new profile for the new client by creating a file including information such as shown in entry 122 of FIG. 2. Based on interactions with the buyer, the controller 202 may initialize the profile and optionally issue a purchase token 193 to the buyer device 104, 106. For example, if the buyer accesses the billing device 112 via the Internet, the billing device 112 may return the purchase token 193 to the buyer device 104, 106 as acceptance of the buyer as a client.

The buyer may contact the billing device 112 to cancel the subscription to the billing service, as discussed above. When such a request is received, the controller 202 informs all the sellers that have authorizing tokens 170 so that the sellers may analyze the outstanding transactions and send invoices for unpaid charges that are due to the sellers. When the controller 202 receives these invoices, the invoices may be paid with the remaining balance in the buyer account on a first-come, first-served basis, for example. If funds still remain in the account after all the outstanding invoices are paid, the controller 202 may refund the remaining amount before deactivating the buyer profile to remove the buyer as a client of the billing service.

If the remaining balance is not sufficient to pay all the sellers, the controller 202 may inform all the unpaid sellers of the shortfall and bill the buyer for the shortfall for a final payment. If the final payment is received from the buyer, the received funds may be used to pay the unpaid sellers before removing the buyer as a client of the billing service. However, if the final payment is not received within a reasonable amount of time, the controller 202 may so inform the unpaid sellers.

If the input received is from a seller, the controller 202 may extract the buyer information by de-encrypting either the purchase token 193 or the authorizing token 170 supplied by the seller and verify that the identified buyer is in fact a client of the billing device 112. If the buyer is not a client (due to cancellation or erroneous message), the controller 202 may issue a message to the seller to indicate that fact. If the buyer is a client of the billing device 112, the controller 202 retrieves the buyer account either from the memory 204 or from a database through the database interface 208. The controller 202 then determines whether the input received is an invoice, a request for approval of a purchase order, an end subscription notification or a purchase cancellation, for example. For an invoice or a request for approval of a purchase order, the controller 202 determines whether the buyer account is sufficient to pay for the invoice or purchase order. If the buyer account is insufficient, the controller 202 returns a deny message to the seller.

For invoices, if the buyer account is sufficient to immediately pay, the controller 202 pays the seller and updates the buyer account. If the buyer account is sufficient to pay at a later time, the controller 202 sends an appropriate message to the seller to indicate a date that the payment may be made, for example. A similar process occurs for approval of purchase orders. If the buyer account (e.g., account balance 128 or uncommitted amount 129,) is sufficient to cover the proposed purchase(s), then the controller 202 sends an authorizing token to the seller that may include such information. If the proposed purchase(s) may only be paid at a later time, the controller 202 may send an authorizing token to the seller that includes a start date, for example. For end subscription notification or purchase cancellation or other common buyer-seller transactions, the billing device 112 updates the buyer account accordingly.

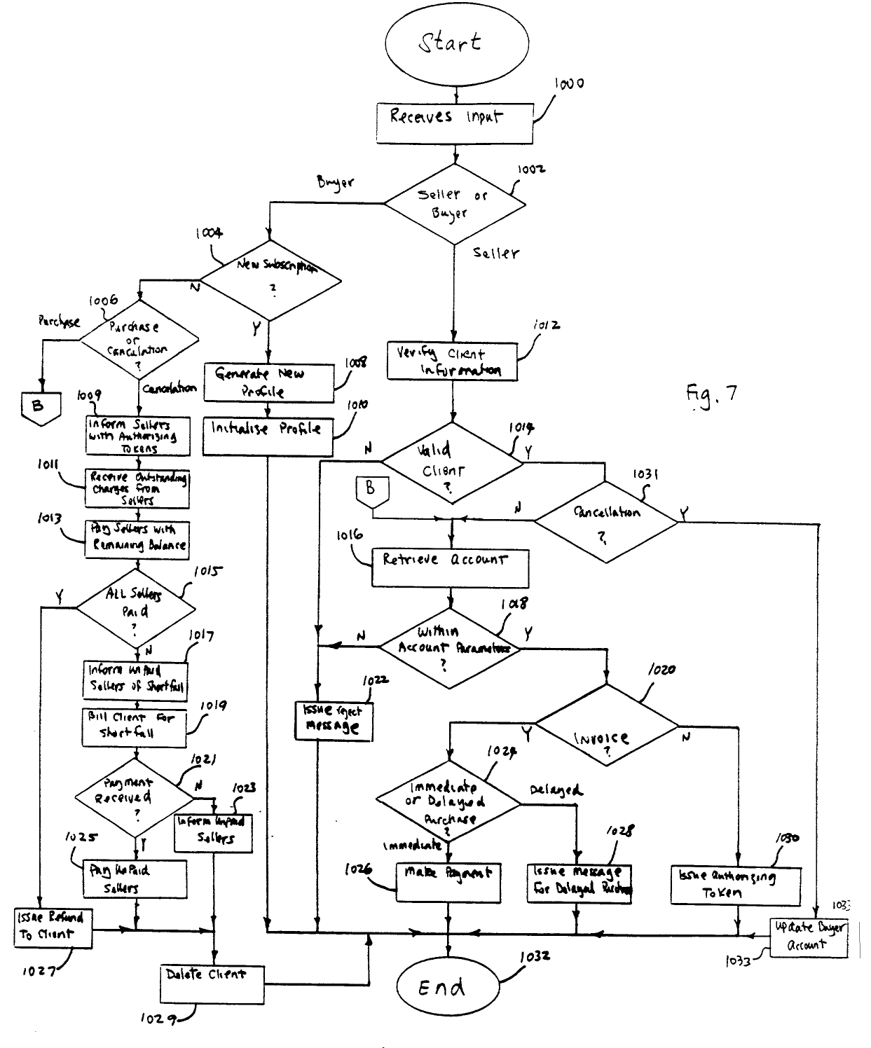

FIG. 7 shows a flowchart of an exemplary process of the billing device 112. In step 1000, the controller 202 receives an input from the network 102 through the network interface 206 and goes to step 1002. The controller 202 determines whether the input is received from a buyer or from a seller. If the input is received from a buyer, the controller 202 goes to step 1004; otherwise the controller 202 goes to step 1012.

In step 1004, the controller 202 determines whether the input received from the buyer is a request for subscribing to the billing service. If a new subscription is requested, the controller 202 goes to step 1008; otherwise, the controller 202 goes to step 1006.

In step 1008, the controller 202 generates a new profile for the new client and goes to step 1010. In step 1010, the controller 202 initializes the profile by interacting with the new client to determine a maximum monthly payment, whether credit is desired, what the billing period should be, etc., for example. After receiving the profile information and the profile is initialized, the controller 202 may issue a purchase token 193 to the buyer to be stored in the buyer's device 104, 106, for example, and goes to step 1032 to end the process.

In step 1006, the controller 202 determines whether the input received from the buyer (a client) is a purchase order or cancellation of the subscription to the billing service. If a purchase order is received, the controller 202 goes to step 1016; otherwise, the controller 202 goes to step 1009.

In step 1009, the controller 202 retrieves from either the memory 204 or a database through the database interface 208 all the sellers that possess authorizing tokens 170 for the buyer. The controller 202 prepares messages for each of the sellers to inform them that the buyer has decided to cancel the billing service and requests each of the sellers to post final invoices of outstanding charges for the buyer, and goes to step 1011. In step 1011, the controller 202 receives the invoices from the sellers and goes to step 1013. In step 1013, the controller 202 pays the sellers with any funds remaining in the buyer account based on a predetermined payment order, such as first-come, first-served, and then goes to step 1015. In step 1015, the controller 202 determines whether all the sellers having outstanding charges have been paid. If all the sellers have been paid, the controller 202 goes to step 1027; otherwise, the controller 202 goes to step 1017. In step 1027, the controller 202 sends a refund of any remaining funds to the canceling and goes to step 1029. In step 1029, the controller 202 deletes the buyer from an active client database and goes to step 1032 to end the process. The controller 202 may retain information regarding the canceling buyer for historical analysis reasons, for example.

In step 1017, the controller 202 informs unpaid sellers of the shortfall. The controller 202 may also indicate that a final bill may be issued to the canceling buyer and if the buyer makes a final payment, the controller 202 will forward the payment to the unpaid sellers. Then, the controller 202 goes to step 1019. In step 1019, the controller 202 sends a final bill to the buyer for the shortfall and goes to step 1021. In step 1021, the controller 202 determines whether a final payment has been received from the canceling buyer. If received, the controller 202 goes to step 1025; otherwise, the controller 202 goes to step 1023. In step 1025, the controller 202 pays the unpaid sellers with the funds received from the final payment and goes to step 1029. In step 1023, the controller 202 sends a final message to the unpaid sellers that no funds have been received and goes to step 1029.

In step 1012, the controller 202 verifies whether the information received from the seller identifies a buyer of the billing device 112. For example, the seller may include a purchase token 193 that has an encrypted buyer information such as shown in FIG. 5, or the seller may include an authorizing token 170 received earlier from the billing device 112, which also includes encrypted buyer information, as shown in FIG. 3. After retrieving the buyer information, the controller 202 goes to step 1014. In step 1014, the controller 202 determines whether the buyer is a client of the billing device 112. If a client, the controller 202 goes to step 1031; otherwise, the controller 202 goes to step 1022. In step 1022, the controller 202 issues a reject message to the seller (or buyer for a purchase order) and goes to step 1032 to end the process.

In step 1031, the controller 202 determines if the input from the seller is a cancellation notice for a purchase or a subscription. If a cancellation, the controller 202 goes to stop 1033; otherwise the controller 202 goes to step 1016. In step 1033, the controller 202 updates the buyer account and goes to step 1032 to end the process.

In step 1016, the controller 202 retrieves the buyer account and goes to step 1018. In step 1018, the controller 202 determines whether the proposed transaction (purchase orders received from either the buyer or the seller, or an invoice) is within the buyer account parameters (e.g., account balance, credit remaining, etc.). If within the account parameters, the controller 202 goes to step 1020; otherwise, the controller 202 goes to step 1022. In step 1020, the controller 202 determines whether the input is an invoice. If an invoice, the controller 202 goes to step 1024; otherwise, the controller 202 goes to step 1030. In step 1030, the controller 202 generates and issues an authorizing token 170 to the seller and goes to step 1032 to end the process. The authorizing token 170 may indicate when the purchase order may be paid by a start date, for example. In step 1024, the controller 202 determines whether the proposed transaction may be completed immediately or delayed. If immediately, the controller 202 goes to step 1026; otherwise, the controller 202 goes to step 1028. In step 1026, the controller 202 makes a payment to the seller, and goes to step 1032 to end the process. In step 1028, the controller 202 sends a message to the seller indicating that the transaction must be delayed to a specified date, for example, and goes to step 1032 to end the process.

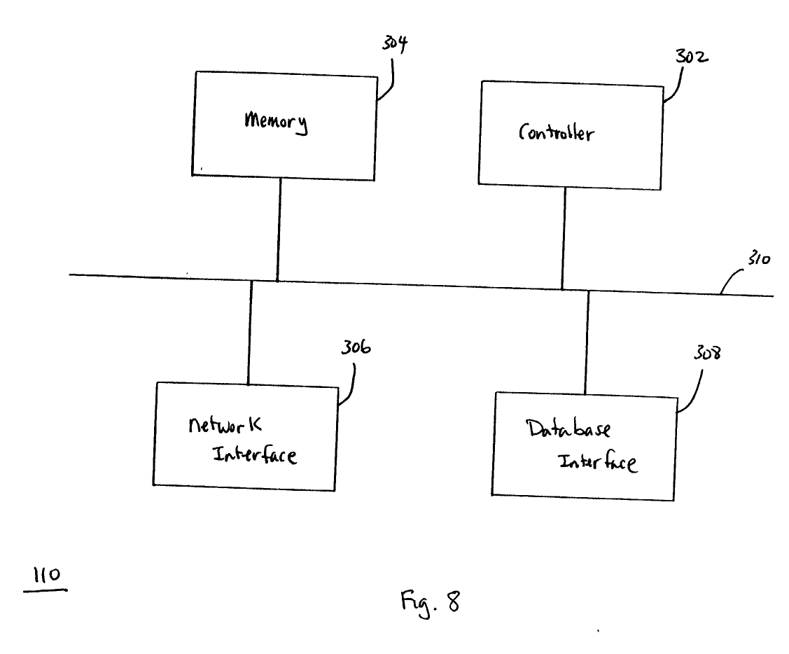

FIG. 8 shows an exemplary block diagram for the seller device 110 as an example of all seller devices 108, 110. The seller device 110 includes a controller 302, a memory 304, a network interface 306 and a database interface 308. The database interface 308 interfaces with other databases which may be distributed throughout the network 102 or attached locally to the seller device 110. The above components are coupled together through a signal bus 310. As with the billing device 112, the diagram shown in FIG. 8 is exemplary for ease of discussion. Other structures are also possible as is well known to one of ordinary skill.

When a purchase request is received through the network 102 and the network interface 306, the controller 302 checks the request to see if either a seller cookie 182 or a purchase token 193 has also been received. If there are no cookies 182, 193 in the purchase request, the controller 302 verifies the purchase request to determine whether the items listed in the purchase request are still being offered and/or whether the prices that the buyer proposes to pay for those items are valid. If either are incorrect, the controller 302 modifies the purchase request to include only those items that are currently being offered and to include only valid prices, electronically signs the purchase request, and returns the purchase request as a proposed purchase order to the buyer. As mentioned earlier, electronic signature of documents are well known in the art and may be performed by encrypting the document using a specific seller key, for example.

The controller 302 waits to receive an authorizing token 170 after sending the proposed purchase order to the buyer. The controller 302 may identify correspondence between received authorizing tokens 170 with a specific purchase request by specifically marking the signed proposed purchase order with a code, for example, and searching for the code in the received authorizing token 170. Thus, the seller need not explicitly identify a particular buyer but merely needs to associate a particular purchase order with a specific authorizing token 170. In this way, the buyer may remain anonymous to the seller. If the authorizing token is not received after an appropriate amount of time, the controller 302 returns a message to the buyer to reject the purchase request because the controller 302 has not received any assurance of payment for the purchase.

If an authorizing token 170 is received, the controller 302 may query the buyer whether the buyer desires for the seller to maintain an account or whether the buyer has made arrangements with the billing device 112 to maintain an account. If the buyer desires the seller to maintain an account, the controller 302 sets up an account for the buyer and interacts with the buyer to set the account parameters such as parameters shown in FIG. 2. After the account is initialized or if the buyer does not desire a seller account, the seller schedules delivery of the purchased item and issues a seller cookie 182 to the buyer. The seller cookie 182 permits the seller to identify the buyer in the future. If the buyer has an account with the seller, future transactions may be completed without additional interaction with the billing device 112.

If a purchase token 193 is found in the purchase order, the controller 302 extracts information from the purchase token 193, seeks approval from the billing device 112, and waits for an authorizing token 170 to be issued by the billing device 112. If an authorizing token 170 is not received (after an appropriate amount of wait time), the controller 302 sends a message to the buyer indicating that the billing device 112 has failed to recognize the buyer. However, if an authorizing token 170 is received, the controller 302 may query the buyer whether an account is desired, as before, and either grants access to seller services if subscription to seller services was purchased or schedules a delivery of the purchase item. Again, the controller 302 may also issue a seller cookie 182 for future accesses of seller services or for future identification of the buyer and/or an account that the buyer has with the seller.

If a seller cookie 182 is found, the controller 302 retrieves any buyer information from a buyer database, for example, via the database interface 308. If the buyer has an account with the seller, the account is retrieved. However, if the controller 302 cannot find any information regarding the seller cookie 182, the controller 302 sends a deny message to the buyer indicating that the seller cookie 182 is invalid. Such a condition may occur if the seller cookie 182 has expired, for example. The deny message may include an invitation for the buyer to provide identification of a billing device 112, for example. In this way, the controller 302 may fill the purchase order and issue a new seller cookie 182 if the billing device 112 issues an authorizing token 170.

After determining whether the seller cookie 182 is valid, the controller 302 determines whether the buyer desires to access seller services based on a prior subscription or to purchase a specific item. If the buyer desires to access services, the controller 302 may update the seller cookie 182 to reset the expiration date, for example, and grants access to the buyer. Other additional information may be included in the new seller cookie 182 such as the time of access and an increment of the number of accesses by this particular buyer. Such data may also be maintained in a database of the seller for management of seller businesses.

If the buyer desires to purchase a specific item, the controller 302, as before, checks if the buyer has an account with the seller. If the buyer does not have an account with the seller, the controller 302 retrieves billing device 112 identification from the seller cookie 182 and issues an invoice to the billing device 112 to verify that the billing device 112 will pay for the new purchase. If the buyer has an account with the seller, the seller may verify the buyer account locally without accessing the billing device 112. In either case, the controller 302 determines whether the purchase order will be accepted based on whether the buyer has sufficient resources in an associate account to pay for the purchase. If the buyer does not have sufficient resources, the controller 302 will send a message to the buyer indicating such a status. However, if the buyer account has sufficient resources, the controller 302 determines whether the resources are sufficient for immediate delivery or a delayed delivery and delivers the purchase accordingly.

In the above description, the seller has a wide variety of options for completing transactions with the buyer. In all of the interactions with the buyer, the buyer may remain anonymous to the seller because the seller only identifies the buyer indirectly either via a billing device 112 or a buyer number that the seller has assigned to the buyer, for example.

In addition, when the seller maintains an account for each of the buyers, multiple transactions with the buyers may be completed without interaction with the billing device 112. The seller may send invoices to the billing device 112 at a time that is independent of the transaction times with the buyer. In this way, efficient administration of the seller's business may be obtained while convenient interaction with the buyer also may be achieved.

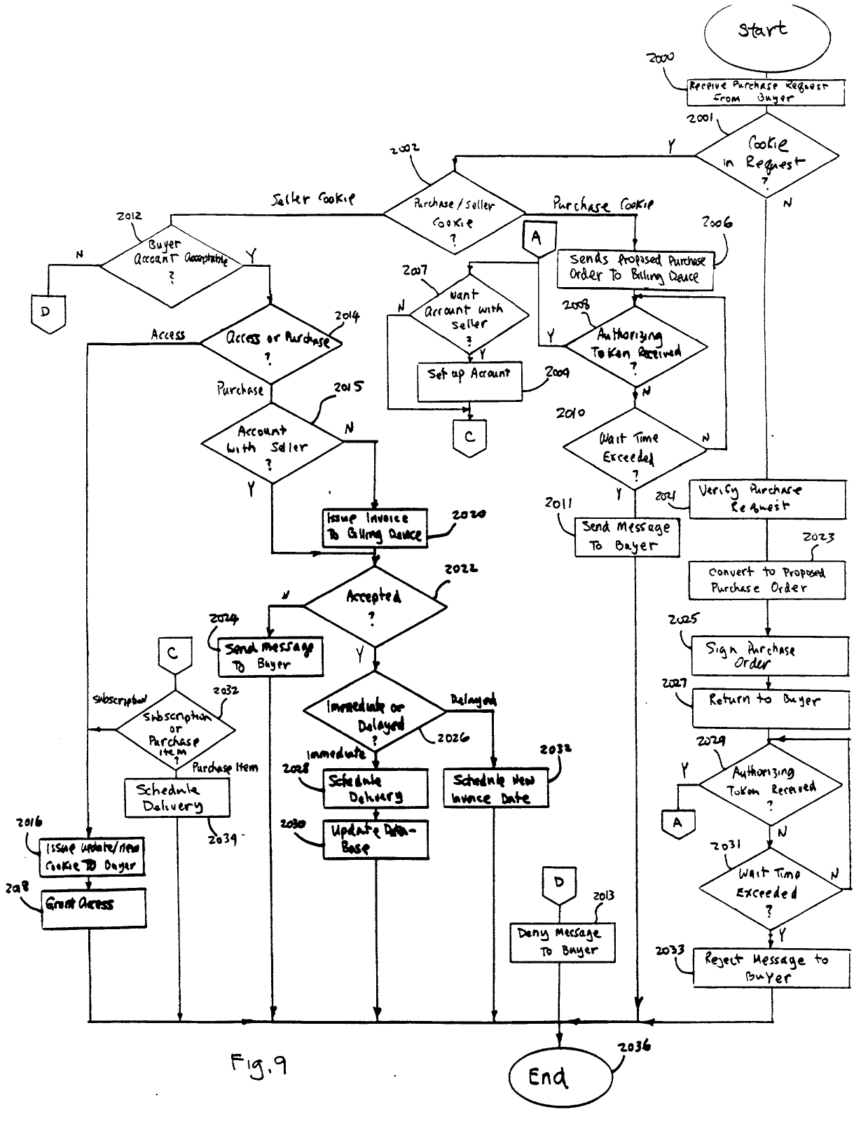

FIG. 9 shows a flowchart of a process of the seller device 108, 110 for processing a buyer purchase request. In step 2000, the controller 302 receives the purchase request from the buyer and goes to step 2001. In step 2001, the controller 302 determines whether a seller cookie 182 or a purchase token 193 is included in the request. If a cookie is included, the controller 302 goes to step 2002; otherwise the controller 302 goes to step 2021.

In step 2021, the controller 302 verifies the purchase request by reviewing the purchase items and determining whether such purchase items are still being offered and also determining whether the prices indicated in the purchase request are correct and goes to step 2023. In step 2023, the controller 302 converts the purchase request into a proposed purchase order by modifying the purchase request as required and adding any identification information for later associating with the authorizing token 170, and goes to step 2025. In step 2025, the controller 302 electronically signs the proposed purchase order. Such electronic signature may be achieved by encrypting the purchase request with a seller specific encryption key, for example. After signing the proposed purchase order, the controller 302 goes to step 2027. In step 2027, the controller 302 returns the proposed purchase order to the buyer and goes to step 2029. In step 2029, the controller 302 determines whether the authorizing token 170 has been received from the billing device 112. If received, the controller 302 goes to step 2007; otherwise, the controller 302 goes to step 2031. In step 2031, the controller 302 determines whether a predetermined amount of wait time has been exceeded. If exceeded, the controller 302 goes to step 2033; otherwise, the controller 302 returns to step 2029. In step 2033, the controller 302 sends a message to the buyer to reject the purchase request and goes to step 2036 to end the process.

In step 2007, the controller 302 queries the buyer whether the buyer desires to maintain an account with the seller. If the buyer chooses to maintain an account with the seller, the controller 302 goes to step 2009; otherwise, the controller 302 goes to step 2032. In step 2009, the controller 302 sets up an account for the buyer and interacts with the buyer to initialize the account with parameters such as shown in FIG. 2 and goes to step 2032.

In step 2032, the controller 302 determines whether the buyer desires to purchase an item or a subscription for seller services. If a subscription is purchased, the controller 302 goes to step 2016; otherwise, the controller 302 goes to step 2034. In step 2034, the controller 302 schedules the delivery of the purchase item (e.g., based on the content of the authorizing token 170 such as the start date) and optionally generates a seller cookie 182 and sends the seller cookie 182 to the buyer device 104, 106, for example. In step 2016, the controller 302 generates a seller cookie 182 and sends the seller cookie 182 to the buyer device 104, 106 and goes to step 2018. In step 2018, the controller 302 grants access to the buyer to access the subscribed to seller services and goes to step 2036 to end the process.

In step 2002, the controller 302 determines whether the purchase request received from the buyer contains a purchase token 193 or a seller cookie 182. If the purchase request contains a purchase token 193, the controller 302 goes to step 2006; otherwise, the controller 302 goes to step 2012. In step 2006, the controller 302 sends a proposed purchase order to the billing device 112 and goes to step 2008. As discussed above, the proposed purchase order is a modified purchase request signed by the seller. In step 2008, the controller 302 determines whether an authorizing token 170 has been received. If an authorizing token 170 has been received, the controller 302 goes to step 2007; otherwise, the controller 302 goes to step 2010. In step 2010, the controller 302 determines whether a predetermined amount of wait time has been exceeded. If exceeded, the controller 302 goes to step 2011; otherwise, the controller 302 returns to step 2008. In step 2011, the controller 302 sends a message to the buyer indicating that the purchase request has been denied because the indicated billing device 112 did not recognize the buyer and invites the buyer to resubmit the purchase request with additional billing device 112 identification, for example. After sending the message to the buyer, the controller 302 goes to step 2036 and ends the process.

In step 2012, the controller 302 retrieves buyer information based on the seller cookie 182. If the buyer is determined to be acceptable (e.g., payments made on prior purchases), the controller 302 goes to step 2014; otherwise, the controller 302 goes to step 2013. In step 2013, the controller 302 issues a purchase request deny message and goes to step 2036 to end the process.

In step 2014, the controller 302 determines whether the buyer desires to access seller services or to make a purchase of a specific item. If access to seller services is desired, the controller 302 goes to step 2016; otherwise, the controller 302 goes to step 2015. In step 2015, the controller 302 determines whether the buyer has an account with the seller or whether the account is maintained with the billing device 112. If the account is maintained by the billing device 112, the controller 302 goes to step 2020; otherwise, the controller 302 goes to step 2022. In step 2020, the controller 302 sends an invoice to the billing device 112 and goes to step 2022.

In step 2022, the controller 302 determines whether the purchase desired by the buyer is acceptable based on the buyer account, either with the seller account or with the billing device 112. If acceptable, the controller 302 goes to step 2026; otherwise, the controller 302 goes to step 2024. In step 2024, the controller 302 sends a message to the buyer to indicate that the buyer account is unacceptable and goes to step 2036 to end the process. In step 2026, the controller 302 determines whether the purchase may be delivered immediately or delayed. For example, if the buyers account has sufficient funds to pay for the purchase, the delivery is made immediately. Otherwise, a delay may be necessary until regular payments made by the buyer to the billing device 112 is accumulated sufficiently to cover the purchase.

If the purchase may be delivered immediately, the controller 302 goes to step 2028; otherwise, the controller 302 goes to step 2032. In step 2028, the controller 302 schedules the delivery and goes to step 2030. In step 2030, the controller 302 updates information regarding the buyer and a buyer database via the database interface 308, for example, and goes to step 2036 to end the process. In step 2032, the controller 302 schedules a new invoice date and goes to step 2036 to end the process.

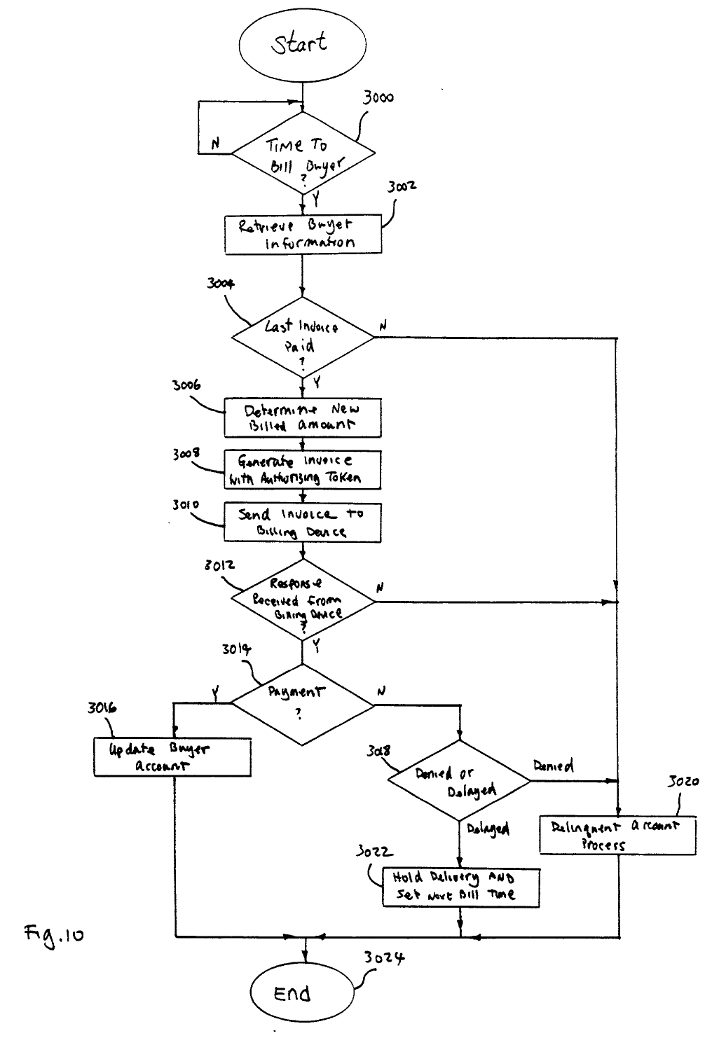

FIG. 10 shows a flowchart of a seller process for billing the buyer at a time that is independent of transactions with the buyer. In step 3000, the controller 302 determines whether it is time to bill the buyer. This billing time may be determined completely based on seller requirements. If it is time to bill the buyer, the controller 302 goes to step 3002; otherwise, the controller 302 returns to step 3000. In step 3002, the controller 302 retrieves the buyer information from either the memory 304 or a database via the database interface 308. If the buyer has an account with the seller, the controller 302 retrieves the account information. If the buyer account is maintained by the billing device 112, the seller retrieves information regarding the buyer and any outstanding charges that are unpaid by the buyer. After retrieving the buyer information, the controller 302 goes to step 3004.

In step 3004, the controller 302 determines whether the last invoice issued by the seller has been paid. If the last invoice has not been paid, the controller 302 goes to step 3020; otherwise, the controller 302 goes to step 3006. In step 3006, the controller 302 determines a new billed amount and goes to step 3008. In step 3008, the controller 302 generates an invoice for the new billed amount and appends the authorizing token 170 corresponding to the buyer to the invoice and goes to step 3010. In step 3010, the controller 302 sends the invoice to the billing device 112 to bill the buyer and goes to step 3012. In step 3012, the controller 302 determines whether a response has been received from the billing device 112. If a response is received, the controller 302 goes to step 3014; otherwise, the controller 302 goes to step 3020.

In step 3014, the controller 302 determines whether payment is received. If payment is received, the controller 302 goes to step 3016; otherwise, the controller 302 goes to step 3018. In step 3016, the controller 302 updates the buyer account and goes to step 3024 to end the process. In step 3018, the controller 302 determines whether the billing device 112 denied or delayed payment for the invoiced amount. If the payment is denied, the controller 302 goes to step 3020; otherwise, the controller 302 goes to step 3022. In step 3020, the controller 302 performs a delinquent account process such as updating buyer information for this particular buyer so that future purchases may be denied, and/or setting a schedule for sending invoices to the billing device 112 for a predetermined amount of times to attempt collection of delinquent payments. After performing the delinquent account process, the controller 302 goes to step 3024 to end the process. In step 3022, the controller 302 may delay delivery of any purchased items or granting access to seller resources and sets a new time period to bill the buyer and goes to step 3024 to end the process.

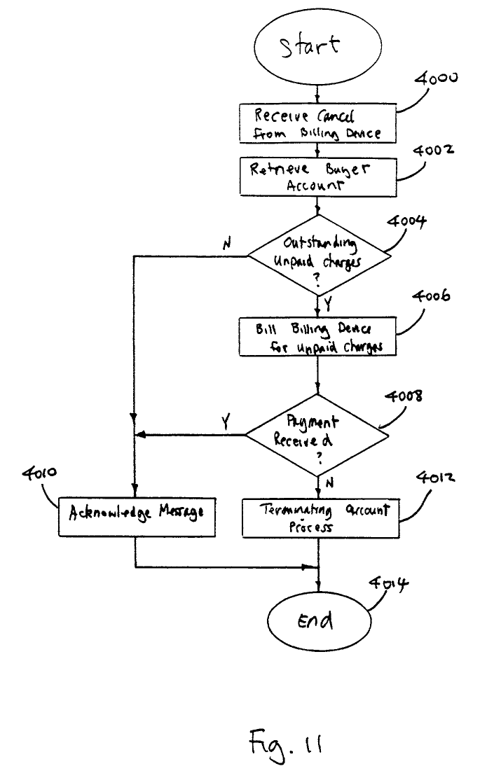

FIG. 11 shows a process of the seller when a cancel message is received from either the billing device 112 or the buyer. In step 4000, the controller 302 receives the cancel message and goes to step 4002. In step 4002, the controller 302 retrieves buyer information such as the buyer account and goes to step 4004. In step 4004, the controller 302 determines whether any outstanding unpaid charges remain for the particular buyer (or unpaid charges if cancellation of a subscription from the buyer) based on identification of the buyer via the authorizing token 170 or seller cookie 182. If outstanding unpaid charges remain, the controller 302 goes to step 4006; otherwise, the controller 302 goes to step 4010. In step 4006, the controller 302 bills the billing device 112 for the unpaid charges (and informs billing device 112 of buyer cancellation if appropriate) and goes to step 4008. In step 4008, the controller 302 determines whether payment has been received from the billing device 112. If payment is received, the controller 302 goes to step 4010; otherwise, the controller 302 goes to step 4012. In step 4010, the controller 302 sends an acknowledgment message to the billing device 112, for example, and goes to step 4014 to end the process. In step 4012, the controller 302 performs a terminating account process such as writing off the unpaid amounts and goes to step 4014 to end the process.

While this invention has been described in conjunction with specific embodiments thereof, it is evident that many alternatives, modifications, and variations will be apparent to those skilled in the art. Accordingly, preferred embodiments of the invention as set forth herein are intended to be illustrative not limiting. Various changes may be made without departing from the spirit and scope of the invention.

What is claimed is:

1. A payment method for transactions conducted over a data network between a buyer and a seller, comprising:
receiving via the data network a request related to the transactions, the request being directed to a payer different from the buyer; and
paying the seller at a payment time independent of a number of the transactions based on a buyer account.

2. The method of claim 1, wherein the payer authorizes a payment commitment between the buyer and the seller by issuing an authorizing token to the seller.

3. The method of claim 2, wherein the request is one of an invoice from the seller for the transactions, or an approval request for a purchase order from either the buyer or the seller, the method further comprising:
retrieving a buyer identification from the request based on either a purchase token or the authorizing token; and
retrieving the buyer account based on the buyer identification.

4. The method of claim 3, wherein if the request is an invoice, the paying step comprises one of:
paying the invoice if that the buyer account is sufficient to pay the invoice;
indicating to the seller a later payment time if the buyer account is insufficient to pay the invoice when received but sufficient to pay the invoice a later time; or
indicating to the seller that the buyer account is unable to pay the invoice.

5. The method of claim 3, wherein the request is the approval request for a purchase order, the method further comprising:
sending the authorizing token to the seller that approves the purchase order if the buyer account is sufficient to pay for the purchase order;
sending the authorizing token that approves the purchase order for a delayed payment time if the buyer account is insufficient to pay for the purchase order when received but sufficient to pay for the purchase order at a later time; or
sending a disapproval message to either the buyer or the seller indicating that the buyer account is unable to pay for the purchase order.

6. The method of claim 3, wherein the purchase token and the authorizing token includes information that at least one of:
identifies the payer; and
identifies the buyer.

7. The method of claim 6, wherein the information identifying the buyer is encrypted so that the buyer may be anonymous to the seller.

8. The method of claim 6, wherein the authorizing token further includes information that identifies the seller.

9. The method of claim 1, wherein the request is an application for a subscription from the buyer for a billing service offered by a billing device, the method further comprising:
recording buyer information in the request;
establishing a buyer profile based on information in the request and/or additional information received from the buyer;
establishing the buyer account; and
establishing accounts for specific sellers as instructed by the buyer.

10. The method of claim 9, further comprising:
generating a purchase token for the buyer; and
sending the purchase token to the buyer.

11. The method of claim 1, further comprising:
receiving a cancellation request from the buyer to cancel the subscription to the billing service;
sending a cancellation message to the seller if the seller has an unexpired authorizing token for the buyer;
receiving a final invoice from the seller;
paying the final invoice if the buyer account has sufficient funds to pay; and
billing the buyer for an unpaid amount.

12. The method of claim 1, further comprising:
receiving a cancellation from the seller to cancel a purchased subscription or a purchased item; and
updating the buyer account to reflect the cancellation.

13. A billing device that pays for transactions conducted over a data network between a buyer and a seller, comprising:
a database; and
a controller coupled to the database, the controller receiving via the data network a request related to the transactions, the request being directed to a payer different from the buyer, and paying the seller at a payment time independent of a number of the transactions based on a buyer account stored in the database.

14. The device of claim 14, wherein the controller authorizes a payment commitment between the buyer and the seller by issuing an authorizing token to the seller.

15. The device of claim 15, wherein the request is one of an invoice from the seller for the transactions, or an approval request for a purchase order from either the buyer or the seller, the controller retrieving a buyer identification from the request based on either a purchase token or the authorizing token, and retrieving the buyer account based on the buyer identification.

16. The device of claim 16, wherein if the request is an invoice, the controller pays the invoice if that the buyer account is sufficient to pay the invoice, indicates to the seller a later payment time if the buyer account is insufficient to pay the invoice when received but sufficient to pay the invoice a later time, or indicates to the seller that the buyer account is unable to pay the invoice.

17. The device of claim 16, wherein the request is the approval request for a purchase order, the controller sending the authorizing token to the seller that approves the purchase order if the buyer account is sufficient to pay for the purchase order, sending the authorizing token that approves the purchase order for a delayed payment time if the buyer account is insufficient to pay for the purchase order when received but sufficient to pay for the purchase order at a later time, or sending a disapproval message to either the buyer or the seller indicating that the buyer account is unable to pay for the purchase order.

18. The device of claim 15, wherein the purchase token and the authorizing token includes information that at least one of:
identifies the payer; and
identifies the buyer.

19. The device of claim 18, wherein the information identifying the buyer is encrypted so that the buyer may be anonymous to the seller.

20. The device of claim 15, wherein the authorizing token further includes information that identifies the seller.

21. The device of claim 13, wherein the request is an application for a subscription from the buyer for a billing service offered by the billing device, the controller recording buyer information in the request, establishing a buyer profile based on information in the request and/or additional information received from the buyer, establishing a buyer account, and establishing up accounts for specific sellers as instructed by the buyer.

22. The device of claim 21, wherein the controller generates a purchase token for the buyer, and sends the purchase token to the buyer.

23. The device of claim 21, wherein the controller receives a cancellation request from the buyer to cancel the subscription to the billing service, sends a cancellation message to the seller if the seller has an unexpired authorizing token for the buyer, receives a final invoice from the seller, pays the final invoice if the buyer account has sufficient funds to pay, and bills the buyer for an unpaid amount.

24. The device of claim 13, wherein the controller receives a cancellation from the seller to cancel a purchased subscription or a purchased item, and updates a buyer account to reflect the cancellation.

25. A method for billing a payer for a plurality of transactions conducted between a buyer and a seller over a data network, comprising:
receiving approval for a first number of purchase orders from the payer different from the buyer;
conducting a second number of the transactions over the data network with the buyer; and
billing the payer for the transactions a third number of times, wherein the first, second and third numbers are independent of each other.

26. The method of claim 25, further comprising:
receiving a purchase request as one of the transactions from the buyer via the data network, the purchase request not including a cookie;
verifying and signing the purchase request;
returning the purchase request to the buyer, the buyer sending the purchase request as the purchase order to the payer for approval; and
filling the purchase order based on an authorizing token received from the payer, the authorizing token being the approval from the payer.

27. The method of claim 26, further comprising:
receiving additional information that indicates payment for the purchase order may be made either immediately or delayed by a specified date.

28. The method of claim 25, further comprising:
receiving a purchase request as one of the transactions from the buyer via the data network, the purchase request including a purchase token;
verifying the purchase request;
converting the purchase request into the purchase order by signing the purchase request;
forwarding the purchase order to the payer for approval based on the purchase token; and
filling the purchase order based on an authorizing token received from the payer, the authorizing token being the approval from the payer.

29. The method of claim 28, wherein the purchase token includes at least one of:
a payer identification; and
a buyer identification; the buyer identification being one of plain text or encrypted text, the encrypted text maintaining the anonymity of the buyer with respect to the seller.

30. The method of claim 25, further comprising:
receiving a transaction request from the buyer via the data network, the transaction request being a transaction of the transactions, the transaction request including a seller cookie;
verifying the transaction request;
retrieving a buyer account;
performing the transaction based on a status of a buyer account without interaction with the payer.

31. The method of claim 25, further comprising:
establishing a buyer account based on buyer instructions;
acquiring approval for parameter values in the buyer account from the payer; and
updating the buyer account based on the first number of transactions without interaction with the payer.

32. The method of claim 25, wherein the parameter values of the buyer account include at least one of:
a periodic payment amount;
an account balance;
an uncommitted amount;
a credit limit;
a credit remaining amount; and
a credit rating.

33. The method of claim 25, further comprising:
generating an invoice independent of the first number of purchase orders and the second number of the transactions; and
sending the invoice as a bill to the payer.

34. The method of claim 25, further comprising:
receiving a cancel message from the payer;
generating an invoice for all outstanding charges for the buyer relating to the payer; and
sending the invoice to the payer for a final payment.

35. The method of claim 25, further comprising:
receiving a cancel request from the buyer;
generating an end notice to the payer, the end notice including any outstanding charges for the buyer related to the payer; and
sending the end notice to the payer.

36. A seller device that billing a buyer for a plurality of transactions conducted with a seller over a data network, comprising:
a database; and
a controller coupled to the database, the controller receiving approval for a first number of purchase orders from a payer different from the buyer, conducting a second number of the transactions over the data network with the buyer, and billing the payer for the transactions a third number of times, wherein the first, second and third numbers are independent of each other.

37. The device of claim 36, wherein the controller receives a purchase request as one of the transactions from the buyer via the data network, the purchase request not including a cookie, verifies and signs the purchase request, returns the purchase request to the buyer, the buyer sending the purchase request as the purchase order to the payer for approval, and fills the purchase order based on an authorizing token received from the payer, the authorizing token being the approval from the payer.

38. The device of claim 37, wherein the controller receives additional information that indicates payment for the purchase order may be made either immediately or delayed by a specified date.

39. The device of claim 36, wherein the controller receives a purchase request as one of the transactions from the buyer via the data network, the purchase request including a purchase token, verifies the purchase request, converts the purchase request into the purchase order by signing the purchase request, forwards the purchase order to the payer for approval based on the purchase token, and fills the purchase order based on an authorizing token received from the payer, the authorizing token being the approval from the payer.

40. The device of claim 39, wherein the purchase token includes at least one of:
a payer identification; and
a buyer identification; the buyer identification being one of plain text or encrypted text, the encrypted text maintaining the anonymity of the buyer with respect to the seller.

41. The device of claim 36, wherein the controller receives a transaction request from the buyer via the data network, the transaction request being a transaction of the transactions, the transaction request including a seller cookie, verifies the transaction request, retrieves a buyer account, performs the transaction based on a status of a buyer account without interaction with the payer.

42. The device of claim 36, wherein the controller establishes a buyer account in the database based on buyer instructions, acquires approval for parameter values in the buyer account from the payer, and updates the buyer account based on the first number of transactions without interaction with the payer.

43. The device of claim 36, wherein the parameter values of the buyer account include at least one of:
a periodic payment amount;
an account balance;
an uncommitted amount;
a credit limit;
a credit remaining amount; and
a credit rating.

44. The device of claim 36, wherein the controller generates an invoice independent of the first number of purchase orders and the second number of the transactions, and sends the invoice as a bill to the payer.

45. The device of claim 36, wherein the controller receives a cancel message from the payer, generates an invoice for all outstanding charges for the buyer relating to the payer, and sends the invoice to the payer for a final payment.

46. The device of claim 36, wherein the controller receives a cancel request from the buyer, generates an end notice to the payer, the end notice including any outstanding charges for the buyer related to the payer, and sends the end notice to the payer.
